(19) United States
(12) Patent Application Publication
(10) Pub. No.: US 2007/0178215 A1
(43) Pub. Date: Aug. 2, 2007

(54) DE-BITTERING CREAMER

(76) Inventors: Christine Ann Beeson, Marysville, OH (US); David Philippe Labbe, Lausanne (CH); Peter Zeltner, Worblaufen (CH); James Tuot, Dublin, OH (US)

Correspondence Address: WINSTON & STRAWN LLP;PATENT DEPARTMENT, 1700 K STREET, N.W., WASHINGTON, DC, 20006, US

(21) Appl. No.: 11/734,133

(22) Filed: Apr. 11, 2007

Related U.S. Application Data
(63) Continuation of application No. PCT/EP05/09930, filed on Sep. 15, 2005.
(60) Provisional application No. 60/622,297, filed on Oct. 26, 2004.

(51) Int. Cl. A23F 5/00

(52) U.S. Cl. 426/594

(57) ABSTRACT

A beverage creamer composition comprises de-bittering agents for reducing or blocking the negative flavor attributes of a beverage, such as artificially sweetened beverages, and coffee. The negative flavor attributes include bitterness, and ashy, or burnt flavors. The de-bittering agent is preferably provided as a blend of sodium salt and potassium salt, a gluconate, a commercial bitter blocker or a combination thereof. Also provided is a beverage system comprising a coffee base component and the creamer composition.

### CROSS-REFERENCE TO RELATED APPLICATIONS

This application is a continuation of International application no. PCT/EP2005/009930 filed Sep. 15, 2005, and claims the benefit of U.S. application No. 60/622,297 filed Oct. 26, 2004. The entire content of each application is expressly incorporated herein by reference thereto.

### FIELD OF INVENTION

The invention relates to a creamer composition for a beverage. The creamer composition comprises a de-bittering agent to reduce or block negative flavor attributes of a beverage. More particularly, it relates to a creamer composition capable of reducing or blocking bitter, ashy, and burnt flavor notes of a beverage. The invention also relates to a beverage system comprising a coffee base and a creamer comprising a de-bittering agent.

### BACKGROUND OF THE INVENTION

Compositions for creamers are well known in the art. Many creamers are provided in dry powder form for addition to beverages that, in the perception or according to the preference of the consumer, require whitening, lightening or creaming. Creamer formulations are also available in liquid or frozen form. Liquid creamers are often encountered in single serve packaging, such as capsules or sachets as well as multiserve packaging.

Generally, creamers are fat emulsions that typically contain fat or oil, carbohydrate, protein, emulsifiers, stabilizers, and buffers. The amounts of these ingredients will vary depending on whether the creamer is powdered, liquid or frozen. Typically, a powdered creamer contains about 25% to 50% fat, 35% to 65% carbohydrate, 3% to 12% protein, 1% to 5% emulsifiers, 1% to 3% buffers, and 0.5 to 3% stabilizers. Generally, powdered creamers are produced by subjecting a solution containing the components to spray-drying.

Certain beverages possess negative flavor attributes, such as bitter, ashy, and/or burnt, flavor notes. Consumer research has shown that many consumers of such beverages dislike the negative flavor attributes associated with such beverages.

Although creamers are well known in the art, none of the current creamers are capable of reducing or blocking bitter, ashy or burnt flavor notes of the beverage to which the creamer is added. For example, EP 1198992 discloses a soluble espresso-type coffee powder having reduced bitterness. The reduced bitterness is achieved by utilizing the aqueous based aroma in a wet mix. The aqueous based aroma which is normally part of the waste product masks the cooked taste of the coffee, but not all of the bitter notes.

U.S. Pat. No. 4,092,438 discloses a non-dairy creamer composition that provides an alternative to conventional creamers having phosphate stabilizing/buffering salts by replacing the phosphate with water soluble acetate salts. Also, U.S. Pat. No. 4,415,600 discloses a spray dried coffee creamer having a buffering agent of phosphate, sodium and potassium salts of acids, such as citric acid, polyphosphoric acid, to hinder protein feathering. While these formulations have some utility, they do not address the problem of masking negative flavor notes in such beverages.

Thus, there remains a need for a creamer capable of providing a smoother beverage with improved organoleptic properties, in particular one in which negative flavor attributes such as bitter, ashy or burnt flavor notes common to some beverages are blocked or reduced. The present invention now satisfies this need.

### SUMMARY OF THE INVENTION

It has surprisingly and unexpectedly been found that creamers and beverage systems that comprise de-bittering agents provide for a smoother, and better tasting beverage. Thus, according to a first aspect of the invention, there is provided a creamer composition comprising a de-bittering agent in an amount sufficient to reduce or block negative flavor attributes of a beverage to which the creamer is added. Preferably, the debittering agent is a sodium salt, a blend of sodium salt and potassium salt, a gluconate, or another commercial additive known as a bitterness blocker.

It has been found that the use of one or more of these de-bittering agents reduces or blocks negative flavor attributes such as bitter, ashy, or burnt flavors that are sometimes associated with certain beverages.

In one embodiment, the de-bittering agent is a sodium salt, preferably a sodium halogen salt, more preferably a salt such as sodium chloride. Preferably, in this embodiment, the creamer composition is substantially free of potassium salts. Preferably, the creamer composition further includes sodium citrate, sodium hexametaphosphate, sodium tripolyphosphate, or a combination thereof. In one preferred embodiment, the creamer composition comprises both sodium citrate and hexametaphosphate, each in an amount of about 0.5 to about 0.65% of the creamer composition.

In another embodiment, the de-bittering agent is a blend of sodium salt and potassium salt, for example and not as a limitation, the sodium or potassium salt may be a fluoride, chloride, phosphate, or a combination thereof. In a preferred embodiment, the amount of sodium salt is about 0.1 to about 2% and the potassium salt is about 0.1 to about 2.5% of the composition.

In another embodiment, the de-bittering agent is a gluconate. Suitable gluconates include calcium gluconate, sodium gluconate, potassium gluconate or mixtures thereof. Preferably calcium gluconate is used. It has surprisingly been found that the calcium gluconate also imparts an enhanced whitening effect to the beverage to which the creamer is added. That is, a creamer comprising calcium gluconate has greater whitening power.

In a further embodiment, as noted above, the de-bittering agent is a bitterness blocker which is commercially available and known in the art. Examples of commercially available bitterness blockers include Ottens BITTERNESS BLOCKER®, Firmenich SWEETNESS ENHANCER®, Quest NATURAL BITTER BLOCKER®, Fontarome MAG-NIFIQUE®, Givaudan MASKING FLAVOR®, or WILD FAE®.

Typically, the de-bittering agent is present in an amount between about 0.01% to about 5% by weight of the creamer composition. Preferably, the de-bittering agent is present in about 0.01% to 3% of the composition.

In a preferred embodiment, the creamer composition comprises a fat or an edible oil, sweetener, protein, emulsifier and de-bittering agent. Additionally, emulsifiers, stabilizers, buffers, and flavors may be included in the creamer composition.

Advantageously, the creamer composition can be in the form of a powder, or liquid and can be a dairy, non-dairy, or a filled-dairy creamer. Additionally, the creamer can be a fat-free, low-fat, or high-fat creamer. In any regard, the creamer composition of the invention can be added to any beverage for both whitening and reducing the negative flavor attributes associated with a beverage. For example, beverage can be an artificially sweetened beverage, coffee, tea, chocolate or a mixture thereof.

According to another aspect of the invention, a beverage system for providing a coffee beverage is provided. The beverage system includes a coffee base component and a soluble creamer component comprising a de-bittering agent. In one embodiment, the coffee base component has a coffee solids concentration of about 0.5% to about 3.0% and a creamer component of about 0.5% to about 5.0% of the beverage system. In one preferred embodiment, the beverage system is a ready-to-drink coffee beverage.

In another embodiment, the coffee base component has a coffee solids concentration of about 25% to about 75% and a creamer component of about 75% to about 25% of the beverage system. In another preferred embodiment, the beverage system is a coffee mix. The coffee base component and the creamer component in combination provide a better tasting and whitened coffee beverage upon reconstitution with water. In this regard, the coffee beverage can be coffee, coffee mix, or even a ready-to-drink coffee beverage.

As the beverage system includes the debittering agents, it advantageously provides a smoother, better tasting coffee beverage, whether it is in the form of a ready to drink beverage, a dispensable coffee product, or a particulate coffee mix.

In a preferred form of the invention, the beverage system is a dry, particulate mixture of coffee and creamer to which water may be added to provide a fresh tasting superior coffee beverage, known in the art as a “two-in-one” coffee. In another embodiment, the beverage system further includes a sweetener, which obviates the necessity of adding sugar or some other type of sweetener conventionally added to coffee, thereby providing a “three-in-one” coffee.

In a further aspect of the invention, a method is provided for making a creamer composition that has de-bittering properties. In one embodiment, the method comprises providing and mixing components such as sweetener, fat, protein, and emulsifier and a solvent to form a wet mix, and adding thereto a de-bittering agent capable of reducing or blocking the negative flavor attributes associated with a beverage. In one embodiment, the de-bittering agent is added to the wet mix of components. The wet mix together with the added de-bittering agent may be pasteurized, homogenized, or both. Subsequently, the mixture may be spray dried to provide dry creamer particles. In an alternative embodiment, the de-bittering agent is added to the components after the wet mix has been dried. For example, the de-bittering agents are dry-blended into the creamer or may be dry-blended into the final dry beverage.

In a further aspect of the invention is provided a debittered coffee product comprising coffee solids and a debittering agent. The coffee product may be a coffee drink or ground coffee particles. The debittering agent may be spray dried on the ground coffee to provide a debittered ground coffee product. In another embodiment, the debittering agent may be added to a coffee drink to provide a debittered coffee product. Preferably, the debittering agent is in a vehicle for delivery into the coffee drink.

One advantage of the invention is that a surprising de-bittering effect is obtainable when the creamer composition is added to a beverage which typically has negative flavor notes. Another advantage of the invention is that the beverage system of the invention provides a smoother tasting coffee beverage due to the reduction of blockage of negative flavor attributes associated with coffee.

### DETAILED DESCRIPTION OF THE PREFERRED EMBODIMENTS

One aspect of the present invention surprisingly and unexpectedly provides a creamer composition that reduces or blocks the negative flavor attributes of a beverage. Typically, the creamer is ready-to-use and is readily dispersible in both hot and cold beverages to provide a smoother and better tasting beverage, while also providing a whitening effect. Beverages that may be used in combination with the creamer include, for example, coffee, tea, and chocolate or any combination thereof. Preferably, the beverage to which the creamer composition is added is coffee.

Accordingly, the creamer composition comprises a de-bittering agent in an amount sufficient to reduce or block the negative flavor attributes of a beverage when the creamer is mixed with the beverage. The term “negative flavor attributes” as used herein includes bitter flavors, ashy flavors, and burnt flavors typically associated with products such as artificially-sweetened beverages, and coffee-type beverages but also includes negative flavor notes associated with other beverages that are provided by extraction of a soluble substance or otherwise.

In one simple step, a beverage consumer combines a creamer with a beverage to not only whiten the beverage, but also to improve the flavor of the beverage to which the creamer is combined.

The creamer can be in the form of a liquid or powder, and can be a dairy, non-dairy, or filled dairy creamer. The term “filled dairy creamer” as used herein is a creamer in which the dairy fat is replaced with a lauric or non-lauric vegetable oil. This advantageously benefits those who prefer to minimize or avoid the intake of dairy products, for example, for health or religious reasons.

The creamer may be a high-fat, low-fat or a fat-free creamer. The term “fat-free” as used herein refers to a creamer that is entirely free of fat, or substantially free of fat such that according to guidelines and rules can be marketed as a “fat-free” product, for example containing from 5% to 15% fat.

The de-bittering agent of the invention preferably includes a sodium salt, a blend of sodium salt and potassium salt, a gluconate, and bitterness blockers, or a combination thereof. The term “bitterness blockers” refers to a commercially available bitterness blockers, which are known in the art. Examples of such commercially available bitterness blockers include Ottens BITTERNESS BLOCKERS® NI-1915-A and Firmenich SWEETNESS ENHANCER® 598960 TP 1054, Quest NATURAL BITTER BLOCKERS®, Fontarome MAG-NIFIQUE®, Givaudan MASKING FLAVOR®, or WILD FAE®, although other commercially available bitterness blockers may be used.

The de-bittering agent is preferably present in an amount of about 0.01% to about 5% of the creamer composition, more preferably between about 0.01% to about 3% by weight based on the total weight of the creamer composition.

It has been surprisingly found that a portion of the population of beverage consumers are sensitive to potassium salts and perceives them as having a bitter taste. Potassium salts are commonly used in conventional creamers as part of a buffering system. Thus, in one embodiment of the present invention the creamer is substantially free of potassium salt and comprises a sodium salt as the de-bittering agent. The term “substantially free of potassium salt” as used herein refers to an taste imperceptible amount of potassium salt such that consumers who are sensitive to such salts do not perceive a bitter flavor from that salt. Thus, the bitter-tasting potassium salt that is typical of conventional creamers is replaced partially or totally with a sodium salt. Additionally, the inclusion of the debittering agent reduces or blocks the bitter taste associated with a beverage such as, but not limited to, coffee. Thus, a much better tasting beverage is provided. In addition to reducing or blocking the bitter taste associated with certain beverages, the creamer composition of the invention also reduces or blocks other negative flavor notes, including ashy and burnt flavor notes.

In a preferred embodiment, the creamer composition is substantially-free of potassium salt and further includes at least one of a citrate salt, a phosphate salt or a combination thereof. Preferred salts of these types include sodium citrate, sodium hexametaphosphate, sodium tripolyphosphate, or a combination thereof. It has surprisingly been found that the addition of such salts helps prevent precipitation of protein due to the change in buffering capacity when partially or totally replacing potassium salt in the creamer. The amount of salt sufficient to prevent precipitation of protein can be readily deduced by the skilled person in the art. Preferably, the sodium citrate and hexametaphosphate are in combination, and are each present in an amount of between about 0.5 to about 0.65% of the creamer composition.

When the de-bittering agent is a blend of sodium and potassium salts, the sodium salt is preferably present in an amount of about 0.5% to about 2% of the creamer composition and the potassium salt is preferably present in an amount of about 0.5% to about 2.5% of the creamer composition.

In another embodiment, the de-bittering agent is calcium gluconate, sodium gluconate, potassium gluconate or mixtures thereof and preferably is calcium gluconate since calcium gluconate also has an enhanced whitening effect on the beverage to which it is added.

As noted above, the de-bittering agent can be a commercially available bitterness blocker, sodium salt, a blend of sodium salt and potassium salt, or a gluconate. Additionally, the de-bittering agent can be a combination of two or more of these de-bittering agents.

Preferably, in addition to de-bittering agents, the creamer comprises a fat or an oil, a sweetener, a protein, and an emulsifier. Optionally, buffering salts may be added. The fat or oil component of the creamer composition may be one or more dairy or non-dairy fats. Suitable non-dairy fats include partially hydrogenated vegetable oil. Preferred non-dairy fats include partially hydrogenated soybean oil, partially hydrogenated canola oil, coconut oil, and palm kernel oil or a combination thereof. In addition, oils that are liquid at room temperature can also be utilized. Other non-limiting examples of suitable fats or oils include cottonseed oil, sunflower oil, oil blends any other similar vegetable oil which will not adversely affect the taste of the product. The fat or oil is preferably present in an amount of about 5 to about 50% of the composition.

The sweetener may be any suitable food grade sweetener, for example those conventionally used in the production of powdered creamers. Examples of suitable sweeteners are sugars such as corn syrup, sucrose, dextrose, fructose, maltodextrin, and the like, and mixtures of these sugars. Corn syrup is particularly suitable (especially dried corn syrup solids) since corn syrup adds bulk to the powdered creamer without imparting excessive sweetness. Maltodextrin, either alone or in combination with other sugars, may also be used; particularly if a product having less sweetness is desired. In any event, the particular sweetener or combination of sweeteners selected is not critical; the primary determining factors being for its selection being the desired taste, sweetness and bulk in the product. The amount of sweetener used will vary depending upon the sweetener, the desired level of sweetness and the strength of the sweetener, but generally this amount will be in the range of about 30 to about 70% by weight of the creamer.

The sweetener may also contain artificial sweeteners such as saccharin, cyclamates, acetosulfame, L-aspartyl based sweeteners such as aspartame, and mixtures of these. If an artificial sweetener is used, it is suitably combined with bulking agents such as maltodextrins and polydextrose. The amount of sweetener is usually in the range of about 30 to about 70% by weight, with the artificial sweetener itself usually being present in an amount of less than 1% by weight.

The protein may be selected from any suitable water-dispersible or soluble protein; for example those normally used in powdered creamers. Examples of such proteins are soy protein, non-fat milk solids, whey solids, casein salts such as sodium and calcium caseinate, rice protein, wheat protein, oat protein, and the like. Mixtures of the various proteins may also be used. Sodium caseinate is most commonly used. The protein is preferably present in an amount from about 0.5 up to about 6%, more preferably from about 2 to about 4% by weight. If the protein source is not pure protein, a greater amount of the protein source may be required to obtain the desired protein level.

The creamer may include an emulsifier, preferably in an amount of about 0.5% to about 1.5% by weight of the powdered creamer. The emulsifier may be selected from monoglycerides, distilled monoglycerides, diglycerides, glycerol monostearates, sorbitol monostearates, esters or carbocyclic acids with mono- and di-glycerides, monosodium phosphate derivatives of mono- and di-glycerides, lecithin, diacetyl tartaric acid esters of mono-diglycerides, sorbitan esters, diacetyl tartaric acid esters of mono-diglycerides (“data esters”), diacetyl tartaric acid esters of di-glycerides, succinylated mono-and di-glycerides, acetylated mono- and di-glycerides, hydroxylated lecithin, propylene glycol mono- and di-esters of fatty acids, polyglycerol esters of fatty acids, polysorbates, lactylic esters of fatty acids, and mixtures thereof. Non-fat milk solids may also be used as an emulsifier. The emulsifier is preferably a mixture of distilled monoglycerides and diacetyl tartaric acid esters of mono-diglycerides. Another preferred emulsifier is a blend containing 60% diacetyl tartaric acid ester of monoglycerides and 40% distilled mono glycerides.

Particularly preferred are distilled monoglycerides (for example those commercially available under the trade name of DIMODAN and obtainable from Danisco Products, Inc. of Kansas, USA) and diacetyl tartaric acid esters of monodiglycerides (for example those commercially available under the trade name of PANODAN and obtainable from Danisco Products, Inc.) as well as succinylated monoglycerides, SMG, from Quest (esters of mono-diglycerides are commonly known as data esters). Additionally, particularly preferred for a powdered creamer is data esters, mono and/or diglyceride, and more preferred is a combination of data esters and mono and/or diglycerides. Particularly preferred for a liquid creamer is lactylic acids, polysorbates, and more preferred is a combination of lactylic acids and polysorbates.

Non-limiting examples of suitable buffers include salts, such as sodium citrate and sodium tripolyphosphate. These are preferably present from about 0.5% to about 1% of the total weight of the composition. Preferred combinations of buffers are dipotassium and/or disodium phosphates with sodium tripolyphosphates, or hexametaphosphate, and citrates.

Optionally, the creamer can include sweeteners and/or flavorings. The sweetener may be a non-caloric, low caloric, or caloric sweetener. Sweeteners impart a wide range of overall sweetness to the creamer. Non-caloric or low-caloric sweeteners generally include a high intensity sweetener and a bulking agent. Bulking agents can help maintain the overall structure and integrity of the creamer while imparting little or no sweetness. Caloric sweeteners generally include sugars or mixtures of sugars, such as fructose, sucrose, dextrose, maltose, lactose, high fructose corn syrup solids, invert sugar, sugar alcohols, and the like, as well as mixtures of these sweeteners. Flavorings are used to deliver one or more specific flavors to the beverage. These flavorings may be natural or artificial in origin. Preferred flavors include amaretto, almond nut, anisette, brandy, mint, chocolate, cinnamon, cinnamon almond, mocha, vanilla, toffee, cappuccino, lemon, macadamia nut, orange, peach, strawberry, grape, raspberry, cherry, coffee, and the like, and mixtures thereof. The addition of flavorings to the creamer further enhances the coffee-drinking experience.

In another aspect of the invention, a beverage system is provided which provides a smoother coffee-type beverage. Accordingly, the beverage system provides a coffee, coffee-mix including a two-in-one coffee, or a three-in-one coffee. The term “two-in-one coffee” refers to a dry coffee mix which includes soluble coffee and soluble creamer in combination such that upon reconstitution with water a whitened, smooth tasting coffee beverage is provided. The term “three-in-one coffee” refers to a dry coffee mix which includes soluble coffee, soluble creamer, and sweetener in combination such that upon reconstitution with water, a whitened, sweetened, smooth tasting coffee beverage is provided.

In other embodiments, the beverage system provides a “ready-to-drink” coffee-type beverage. Thus, the beverage is already reconstituted with water and the consumer can simply open the package and enjoy a better tasting smooth coffee drink.

Accordingly, the beverage system comprises a coffee base component and a creamer component comprising a de-bittering agent. In one embodiment, the coffee base component has a coffee solids concentration of about 0.5 to about 3.0% by weight; and a creamer component concentration of about 0.5 to 5.0% of the creamer composition, and the beverage is a ready-to-drink coffee. In another embodiment, the coffee base component has a coffee solids concentration of about 25% to about 75% and a creamer component composition of about 75% to about 25% and the beverage is a coffee mix. Preferably, the de-bittering agent is present in an amount of about 0.01% to about 5% by weight of the creamer component.

In some embodiments, and as mentioned above, the beverage system is in the form of a coffee, coffee mixture, or a ready-to-drink coffee beverage. In one embodiment, the coffee system further comprises a sweetener component to provide a sweetened drink.

The de-bittering agent for this system is any one or more of the de-bittering agents mentioned herein.

In a preferred method of making the creamer composition according to the invention, the required ingredients can be gathered together, adding them into a mixing vessel containing a measured quantity of solvent and forming a wet mix with them, preferably at a temperature in the range from about 78 to 82° C., more preferably about 80° C. The mix may be pasteurized and homogenized in preferably a two-stage process, thereafter.

In a particularly preferred method for making the creamer, the components are added to the vessel and solvent sequentially. Preferably, the salt or salts are added to the solvent, which is preferably water at about 80° C. Thereafter, protein, preferably caseinate, is added to the water with any buffering salts. Then the fat is added, followed by corn syrup solids, and emulsifiers. Thereafter, de-bittering agent, colorant, flavorant and salt is added. The sequential additions of components into the solvent form a wet mix. The wet mix is then pasteurized at a temperature of about 82 to 83° C., preferably, 82.2° C. for about 10 to 15 seconds, preferably, 12 seconds. The homogenization step preferably comprises two stages. The homogenized mixture is preferably spray dried to approximately 3.0 to about 3.5% moisture. The de-bittering agent as noted above can be added to the wet mix, or alternatively, may be added after the mixture is dried. Filling may be in any suitable container, from relatively inflexible bottles, jars and the like to flexible tubes, sachets, pouches, bags and the like.

The creamer of this invention is found to be suitable for use not only with traditional warm beverages such as artificially flavored beverages, coffee, tea, cocoa, chocolate and malt drinks, but also with cold drinks such as artificially flavored drinks, iced coffee, and iced tea.

The creamer package may, in an embodiment, comprise a sterilized transparent glass or plastics jar or tube with a suitable sealing lid for single or multiple servings. Alternatively it could be equipped with a dispensing device associated with the top of the jar or tube—for example a dosage system or nozzle arrangement.

In a further aspect of the invention, there is provided a debittered coffee product comprising coffee and a de-bittering agent. In one embodiment, the coffee product may be a coffee drink or a ground coffee product. Advantageously, the de-bittering agent can be used to reduce or block negative flavor attributes of the coffee without whitening the coffee.

In one embodiment, the debittering agent is spray dried on the ground coffee to provide a debittered ground coffee product. Spray drying is well known in the art and any suitable spray-drying method can be adopted for this purpose. Thus, the debittered coffee ground upon reconstitution with water provides a debittered coffee product. The coffee may be whitened by conventional creamers or milk, or can be enjoyed as black coffee. In another embodiment, the debittering agent is added to a prepared cup coffee drink to provide a debittered coffee. In this regard, the de-bittering agent may be dissolved or dispersed in a vehicle such as water or a syrup mixture. Alternatively, the de-bittering agent may be in a powder form so that it is added to a cup of coffee much like sugar or a sugar substitute.

Advantageously, the de-bittering agent may be in the form of a single serving package e.g. sachets, capsules or envelopes, to provide the user with a convenient serving of de-bittering agent for a cup of coffee. Single serve packaging may include a sealed, transparently-walled capsule or canister having a removable sealing membrane, such as a peelable lid. The single serving can also be in liquid form such that a small plastic container having a capacity of about 15 to about 30 ml can contain the debittering agent. In powder form, satchets can include 0.5 to 1 gram of agent. These selected single servings can be used in multiples to satisfy the desired flavor enhancements of the beverage by a particular consumer.

Alternatively, a liquid or syrup form of the de-bittering agent may be provided in a convenient container with a pump and nozzle that upon activation provides a single serving of the de-bittering agent mixture. Advantageously, black coffee drinkers can have a cup of black coffee with reduced or blocked negative flavor attributes.

A suitable vehicle comprises water and a sugar, such as maltodextrin although other vehicles such as simply the de-bittering agent and water, or a syrup mixture comprising the de-bittering agent, can be used.

It will be appreciated by the person skilled in the art that numerous modifications may be made to the relative proportions and selections of the various components, without departing from the scope of the invention.

What is claimed is:

1. A creamer composition comprising a de-bittering agent present in an amount sufficient to reduce or block negative flavor attributes associated with a beverage to which the creamer is added.

2. The creamer composition of claim 1, wherein the de-bittering agent is selected from the group consisting of a sodium salt, a blend comprising a sodium salt and a potassium salt; a gluconate; a bitterness blocker; and a mixture thereof, and wherein the negative flavor attributes of a beverage include bitter flavor notes, ashy flavor notes, or burnt flavor notes.

3. The creamer composition of claim 1, wherein the de-bittering agent is a sodium salt and the creamer composition is substantially free of potassium salts.

4. The creamer composition of claim 1, wherein the de-bittering agent is a sodium halogen salt.

5. The creamer composition of claim 1, wherein the de-bittering agent is a blend of a sodium salt and a potassium salt comprising from about 0.1 to about 2% of the sodium salt, and from about 0.1 to about 2.5% of the potassium salt.

6. The creamer composition of claim 1, wherein the de-bittering agent is calcium gluconate, sodium gluconate, potassium gluconate, or mixtures thereof.

7. The creamer composition of claim 6, wherein the gluconate is calcium gluconate and is present in an amount to impart enhanced whitening power to the beverage.

8. The creamer composition of claim 1, wherein the creamer composition further includes a citrate salt, a phosphate salt or a combination thereof in an amount sufficient to prevent precipitation of protein.

9. The creamer composition of claim 8, wherein the citrate salt is sodium citrate or the phosphate salt is sodium hexametaphosphate.

10. The creamer composition of claim 9, wherein the creamer includes sodium citrate and hexametaphosphate in combination, each present in an amount of between about 0.5 to about 0.65% by weight of the composition.

11. The creamer composition of claim 1, wherein the de-bittering agent is present in an amount of between about 0.01% to about 5% by weight of the creamer composition.

12. The creamer composition of claim 1, in dry form.

13. The creamer composition of claim 1, in the form of a non-dairy, dairy creamer, or filled dairy creamer.

14. The creamer composition of claim 1, which comprises about 30 to about 70% of a sweetener, about 5% to about 50% of an edible fat or oil; and about 2 to about 4% of a protein.

15. The creamer composition of claim 14, wherein the sweetener is corn syrup solids, and the protein is a casein salt.

16. A beverage system that includes a whitening effective amount of the creamer composition of claim 1.

17. The beverage system of claim 16, wherein the beverage to which the creamer composition is added comprises artificially flavored beverages, coffee, tea, chocolate, cocoa or a combination thereof.

18. A beverage system comprising a coffee base component and the creamer composition of claim 1.

19. The beverage system of claim 18 in the form of a dry particulate mixture, wherein the coffee base component has a coffee solids concentration of about 25 to about 75% by weight; and the creamer composition is present in an amount of about 75 to 25%.

20. The beverage system of claim 18, in the form of a ready-to-drink coffee beverage.

21. The beverage system of claim 18, further comprising a sweetener.

22. A method of making a creamer composition having de-bittering properties, the method comprising the steps of:
(i) providing, as components, a fat or oil, a sweetener, a protein and an emulsifier,
(ii) mixing the components in a solvent to form a wet mix; and
(iii) adding a de-bittering agent in an amount sufficient to reduce or block the negative flavor attributes of a beverage when added thereto.

23. The method of claim 22, wherein the wet mix is pasteurized.

24. The method of claim 23, which further comprises the step of homogenizing the wet mix and drying the homogenized wet mix.

25. The method of claim 24, wherein the de-bittering agent is added to the components after the drying step.

26. The method of claim 22, wherein the de-bittering agent is added to the wet mix.

27. A method of reducing or blocking negative flavor attributes of a beverage which comprises adding to the beverage the creamer composition of claim 1 in an amount effective to reduce or block such negative flavor attributes.

28. The method of claim 27, wherein the negative flavor attributes include bitter flavor notes, ashy flavor notes, or burnt flavor notes and the beverage comprises coffee, tea, chocolate, cocoa or a combination thereof.

29. A debittered coffee product comprising coffee and a debittering agent.

30. The debittered coffee product of claim 29, wherein the coffee product is a coffee drink, and further wherein the debittering agent is in a vehicle for delivery in the drink.

31. The debittered coffee product of claim 29, wherein the product is ground coffee and the debittering agent is spray dried on the ground coffee.

32. The debittered coffee product of claim 29, wherein the debittering agent is a sodium salt, a blend of sodium and potassium salt, a gluconate or a commercially available bitterness blocker.

33. The debittered coffee product of claim 30, wherein the vehicle comprises water or a sugar.

34. A method for reducing or blocking negative flavor notes of a beverage comprising adding a de-bittering agent selected from a sodium salt, a blend of sodium salt and potassium salt, a gluconate, and a commercially available bitterness agent to a beverage having negative flavor notes.

35. The method of claim 34, wherein the de-bittering agent is in the form of a powder, and further wherein the de-bittering agent is provided in a single serving packaging.

36. The method of claim 34, wherein the de-bittering agent is in the form of a liquid.

37. The method of claim 36, wherein the liquid is viscous, and further wherein the viscous liquid is packaged in a container having a nozzle for dispersing a serving of de-bittering agent.
